(19) United States
(12) Patent Application Publication
(10) Pub. No.: US 2013/0271570 A1
(43) Pub. Date: Oct. 17, 2013

(54) PROGRAM INFORMATION DISPLAY DEVICE, TELEVISION RECEIVER, PROGRAM INFORMATION DISPLAY METHOD, PROGRAM INFORMATION DISPLAY PROGRAM, AND STORAGE MEDIUM

(71) Applicants: Kouhei Wakabayashi, Osaka-shi (JP); Takayuki Suzuki, Osaka-shi (JP)

(72) Inventors: Kouhei Wakabayashi, Osaka-shi (JP); Takayuki Suzuki, Osaka-shi (JP)

(73) Assignee: SHARP KABUSHIKI KAISHA, Osaka-shi, Osaka (JP)

(21) Appl. No.: 13/994,394

(22) PCT Filed: Jan. 16, 2012
(86) PCT No.: PCT/JP2012/050667

§ 371 Date: Jun. 14, 2013

(51) Int. Cl. H04N 13/04

(52) U.S. Cl. CPC H04N 13/0454
USPC 348/43

(57) ABSTRACT

Provided is a program information display technique that allows the user to easily find a desired program using 3-D display images. A program information display device according to the present invention displays 3-D images of program information conforming to user preferences regarding programs. This program information display device also adjusts the degree of protrusion of the 3-D display depending on the importance of the program information.

### TECHNICAL FIELD

The present invention relates to a technique for displaying program information.

### BACKGROUND ART

In recent years, the number of video display device that can display videos in 3D display format has increased, and interests in 3D videos have grown. In addition, techniques that convert videos in 2D display format into 3D display format have appeared.

Patent Literature 1 listed below describes a technique in which information such as number of TV programs that are not to be displayed in an electronic program guide is indicated by three-dimensionally displaying the relevant program guide cell. In the patent literature, the program guide is generally displayed in 2D display format and the cell having the stated information is converted into 3D display format.

Patent Literature 2 listed below (claims 9 to 11, FIG. 9, and so on) describes a technique in which a program cell currently selected is displayed three-dimensionally.

### CITATION LIST

### Patent Literature

### Patent Literature 1: WO 2007/099803 A

### Patent Literature 2: JP Patent Publication (Kokai) 2008-182287 A

### SUMMARY OF INVENTION

### Technical Problem

The techniques described in the stated Patent Literature 1 and 2 describe techniques in which program cells are displayed three-dimensionally. However, the 3D-displayed program cells have no special meanings unique to respective users.

For example, in Patent Literature 1, the 3D-displayed program cells only indicate that non-displayed information is hidden, and it doesn't indicate information unique to users. In addition, in Patent Literature 2, currently selected program cells are 3D-displayed. Thus the 3D-displayed cell is changed as the selection changes, and it doesn't indicate information unique to users.

The present invention has been made to solve the problem stated above, and it is an object to provide a technique for displaying program information that can easily find programs required by users using 3D display videos.

### Solution to Problem

A program information display device according to the present invention displays program information that matches with users' preferences for programs. In addition, a protrusion amount of the 3D display is adjusted according to an importance of the relevant program information.

### Advantageous Effects of Invention

With a program information display device according to the present invention, since program information protrudes frontward more as it matches with users' preferences better, the users can find preferred programs easily.

### BRIEF DESCRIPTION OF DRAWINGS

FIG. 1 is a functional block diagram of a program information display device 200 according to an embodiment 1.

FIG. 2 is a diagram illustrating a configuration example and a data example of user preference information 221 stored in a storage unit 220.

FIG. 3 is a screen image diagram illustrating that a screen display unit 240 displays a program guide in a 2D display format.

FIG. 4 is a screen image diagram illustrating that the screen display unit 240 displays a part of program cells of the program guide in a 3D display format.

FIG. 5 is a screen image diagram of a program guide in a second embodiment.

FIG. 6 is a screen image diagram at which two hours have passed with the screen state of FIG. 5 unchanged.

FIG. 7 is a screen image diagram illustrating a modified example of an operation making a protrusion amount of a program cell near current time larger.

FIG. 8 is a diagram illustrating an operation example selecting a display format of a program video according to a display format of a program cell.

FIG. 9 is a screen image diagram when displaying a program video and a program guide on a same screen.

FIG. 10 is a diagram illustrating a configuration example in which an information amount of a program cell is increased.

FIG. 11 is a diagram illustrating a configuration example in which a character size of a program cell is enlarged.

FIG. 12 is a functional block diagram of a program information display device 200 according to an embodiment 6.

FIG. 13 is a diagram illustrating a display example in which a program cell is semitransparent.

FIG. 14 is a diagram illustrating a display example in which a gap between program cells is broadened.

FIG. 15 is a diagram illustrating a display example in which a size of a program cell is reduced.

FIG. 16 is a diagram illustrating a display example in which a size of a program cell is reduced and a gap between characters in the cell is narrowed.

FIG. 17 is a diagram illustrating a display example in which a size of character strings in a program cell is reduced.

FIG. 18 is a diagram illustrating a display example in which an arrangement of character strings in a program cell is changed.

FIG. 19 is a block diagram illustrating a configuration of a television 1 according to an embodiment 8.

### DESCRIPTION OF EMBODIMENTS

### Embodiment 1

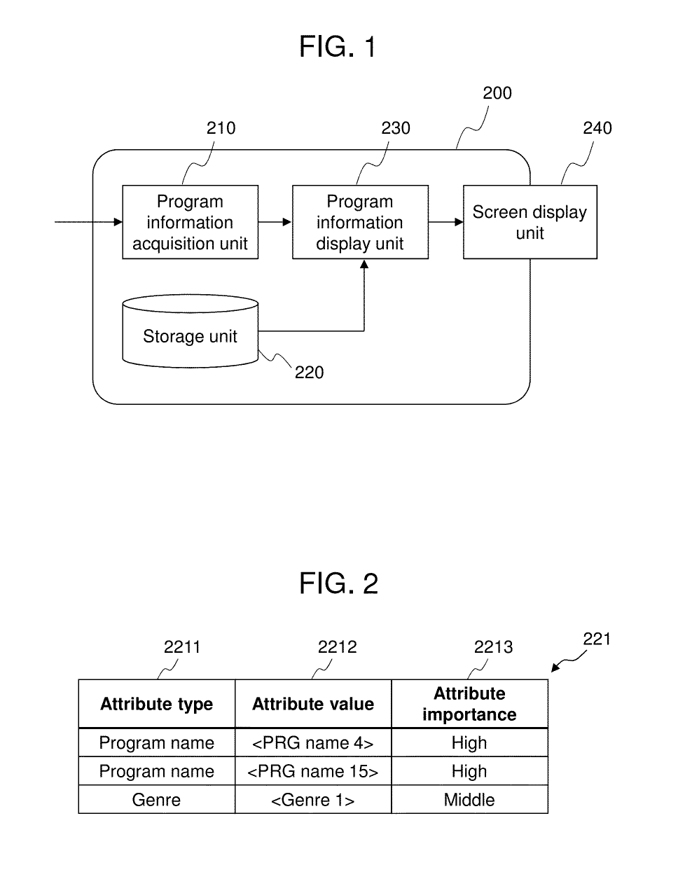

FIG. 1 is a functional block diagram of a program information display device 200 according to an embodiment 1 of the present invention. The program information display device 200 is a device for displaying program information and includes a program information acquisition unit 210, a storage unit 220, a program information display unit 230, and a screen display unit 240.

The program information acquisition unit 210 acquires an electronic program guide describing program information. It could be considered that the program information acquisition unit 210 acquires the electronic program guide by ways of such as: acquiring the electronic program guide by connecting with a program information providing server through a network; acquiring program information superimposed in a broadcast wave; and acquiring the electronic program guide by reading it from a storage medium storing program information.

The storage unit 220 stores user preference information 221 describing a user's preference for programs or program attributes. The user preference information 221 describes programs required by the user or their attributes such as, for example, a program genre preferred by the user, a specific program name, and a channel. The user specifies, to the program information display device 200, preferred program genres and the like as description contents of the user preference information 221. The program information display device 200 stores the specified description contents into the storage unit 220.

The program information display unit 230 formats the program guide into a predetermined display format using the program information acquired by the program information acquisition unit 210 and the user preference information stored in the storage unit 220, and instructs the screen display unit 240 to display the program guide. The screen display unit 240 displays the program guide.

The program information acquisition unit 210 and the program information display unit 230 can be configured using hardware such as a circuit device for realizing their functions or can be configured by using an arithmetic device such as a microcomputer or a central processing unit (CPU) and software for defining the operation of the arithmetic device.

The storage unit 220 can be configured by using a storage device such as a hard disk drive (HDD). The screen display unit 240 can be configured by using a screen display device such as a liquid crystal display device. The program information display unit 230 and the screen display unit 240 can be configured in an integrated fashion. Hereinafter, for the sake of description, those units are described as separated.

FIG. 2 is a diagram showing a configuration example and a data example of the user preference information 221 stored in the storage unit 220. A data example in a table format is shown in FIG. 2. However, any data format could be employed. The user preference information 221 includes an attribute type column 2211, an attribute value column 2212, and an attribute importance column 2213.

The attribute type colunm 2211 describes a type of program attribute preferred by the user. The user may describe, in the user preference information 221, program attributes such as a preferred program name, a preferred program genre, and the like as the user's preferences. This column is provided in order to clarify which program attributes the preferences are set to.

The attribute value column 2212 describes a preferred program attribute value set by the user. If the value of the attribute type column 2211. is “genre”, the attribute value column 2212 describes program genre names such as “sports program” or “drama”. If the value of the attribute type column 2211 is “program name”, the attribute value column 2212 describes attribute information by which specific programs can be identified such as a program name itself or a broadcast channel and its time slot.

The attribute importance column 2213 describes a value indicating how much important the value of the attribute value column 2212 is for the user. It is generally assumed that, if a user designates a specific program as the user's favorite, the user doesn't want to miss the program, thus it is supposed that the user sets a high value into this column. It is assumed that, if the user designates a specific program genre as the user's favorite, the user casually wants to watch the program if possible, thus it is supposed that the user sets a not-very-high value into this column.

The configuration of the program information display device 200 is described as above. Next, an operation in which the program information display device 200 three-dimensionally displays program information will be described.

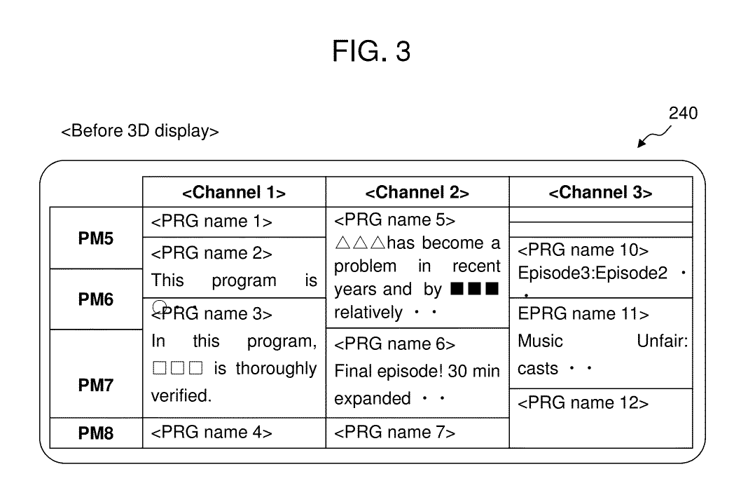

FIG. 3 is a screen image diagram showing that the screen display unit 240 displays a program guide in a 2D display format. The program information display unit 230, when displaying a program guide on the screen display unit 240, acquires the user preference information 221 and determines whether program information matching with the description of the user preference information 211 exists in the screen. If no matching program information exists in the screen, the program information display unit 230 generates a program guide screen image in a 2D display format and instructs the screen display unit 240 to display it.

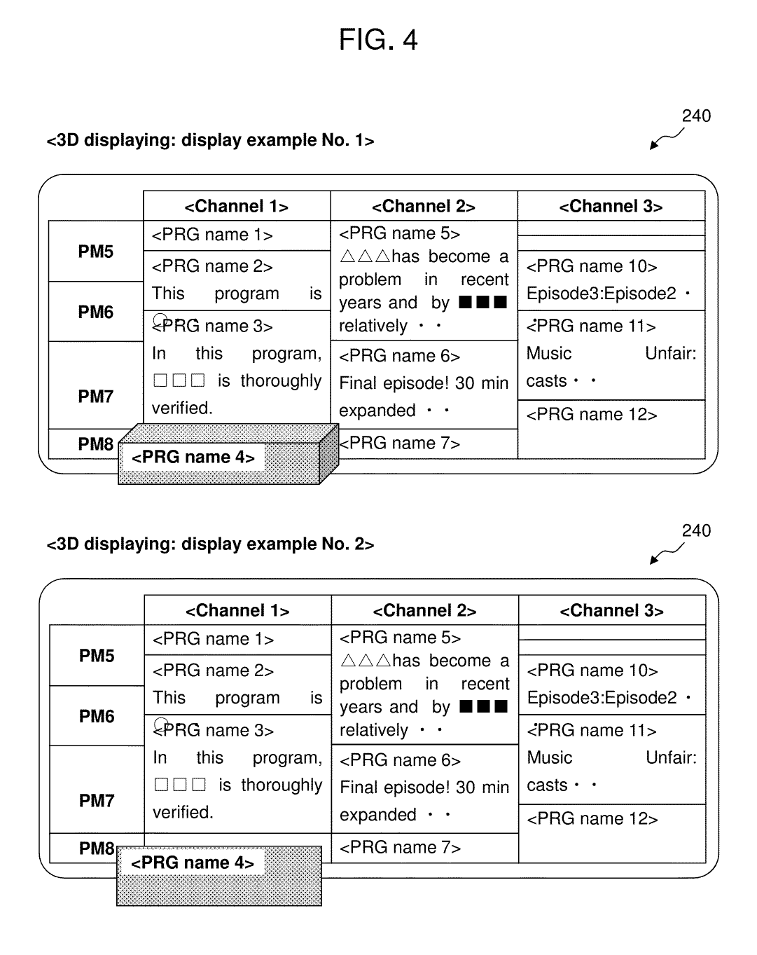

FIG. 4 is a screen image diagram in which the screen display unit 240 is displaying a part of program cells of the program guide in a 3D display format. FIG. 4 describes a screen image that the user's eye sees.

The program information display unit 230, if program information matching with the description of the user preference information 211 exists in the screen, converts the program cells displaying the relevant program information into a 3D display format and instructs the screen display unit 240 to display it.

As methods for converting a program cell into a 3D display format, any commonly known technique can be employed. For example, the screen display unit 240 may be configured using a display device employing a parallax barrier technique utilizing a parallax between left and right eyes, and the function of the screen display unit 240 displays program cells in a protruded manner. Besides, the user may previously equip a glasses device for 3D display and the program information display device 200 and the 3D display glasses device may cooperate to provide with 3D displays.

In FIG. 4, a program cell matching with the first row of the user preference information 221 “PRG name 4” exemplified in FIG. 2 exists in the screen. Thus the program information display unit 230 three-dimensionally displays the program cell by protruding it visually. FIG. 4 shows two display examples. FIG. 4 upper diagram shows an example in which a side surface is added to the program cell to stereoscopically display it. FIG. 4 lower diagram shows an example in which the program cell is displayed in a protruded manner without adding side surfaces.

In FIG. 4 upper diagram, for the sake of explanation as a screen image, an example in which the program cell is stereoscopically displayed is shown. However, when three-dimensionally displaying the program cell matching with the user preference information 221 to protrude the program cell, it is not necessary to stereoscopically display the relevant program cell. By utilizing a parallax between left and right eyes, even without stereoscopically displaying the program cell, a feeling of protrusion can be sufficiently obtained from the screen image shown in FIG. 4 lower diagram.

In both cases of FIG. 4 upper and lower diagrams, the program cell displayed three-dimensionally exceeds the boundary of the screen display unit 240. This shows a screen image viewed from the user. The user sees the program cell as if it is nearer to the user than the actual location of the screen display unit 240, thus the program cell could be seen as if it exceeds the boundary of the screen display unit 240 as shown in FIG. 4.

Namely, the program cell three-dimensionally displayed in the embodiment 1 not merely stereoscopically displays the program cell like a perspective view but exhibits a 3D display effect positively utilizing a visual effect due to parallax between left and right eyes.

The program information display unit 230, when displaying the program cell matching with the description of the user preference information 221 in a 3D display format, may adjust the protrusion amount of the program cell according to the value of the attribute importance column 2213 corresponding to the relevant program cell. For example, an adjusting method could be contemplated in which a program cell describing program information with higher importance has larger amount of protrusion so that the program cell may be more easily caught by the user's eyes.

In FIG. 4, the program information display unit 230 may arbitrarily adjust, when displaying a program cell three-dimensionally, drawing parameters such as a protrusion amount of the 3D cell, a location, a cell size, and a character size so that the information described by peripheral program cells is not hidden. It also applies in following embodiments when three-dimensionally displaying program cells.

### Embodiment 1

### Summary

As described above, the program information display device 200 according to the embodiment 1 displays a program cell matching with a user's program preference described in the user preference information 221 in a 3D display format as if the program cell protrudes. This allows the user to immediately find the program information matching with the user's favorites in the program guide, thereby effectively utilizing the 3D display effect in program selecting operations on the program guide.

In addition, the program information display device 200 according to the embodiment 1 adjusts the protrusion height of the 3D display so that a program cell with high importance can be seen as if it protrudes significantly. This allows the user to visually understand how much the program matches with the user's own favorites. Thus the user can more easily select preferred programs on the program guide. Namely, according to the technique described in the embodiment 1,the 3D representation can be effectively utilized in user navigations.

### Embodiment 2

In the embodiment 1, an operation example is described in which program cells are three-dimensionally displayed according to users' preferences and importance. On the other hand, considering a user's mind when selecting programs on program guides, it can be supposed that the user may frequently select programs near the current time. Thus in the embodiment 2 of the present invention, an example will be described in which program cells are three-dimensionally displayed with the current time taken into account. The configuration of the program information display device 200 is the same as the embodiment 1.

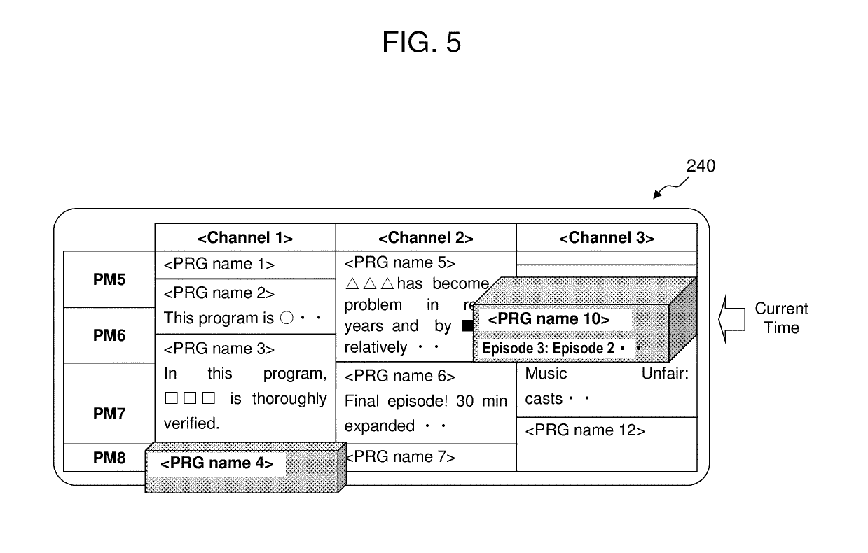

FIG. 5 is a screen image diagram of a program guide in the embodiment 2. In FIG. 5, it is assumed that there are two programs (PRG name 4 and PRG name 10) matching with the user preference information 221. The program information display unit 230 displays the program cells matching with the user preference information 221 in a 3D display format according to the operation described in the embodiment 1.

In the embodiment 2, the program information display unit 230 adjusts, in addition to or instead of the value of the attribute importance 2213 described in the user preference information 221, the protrusion amount of program cells so that the program cell having a broadcast time closer to current time protrudes more frontward.

In FIG. 5, assuming that the current time is 18:00, the program information display unit 230 makes the program cell of PRG name 10 having a broadcast time close to 18:00 protrude larger than usual. The program cell of PRG name 4. far from the current time may protrude as usual or protrude less frontward according to the distance from the current time.

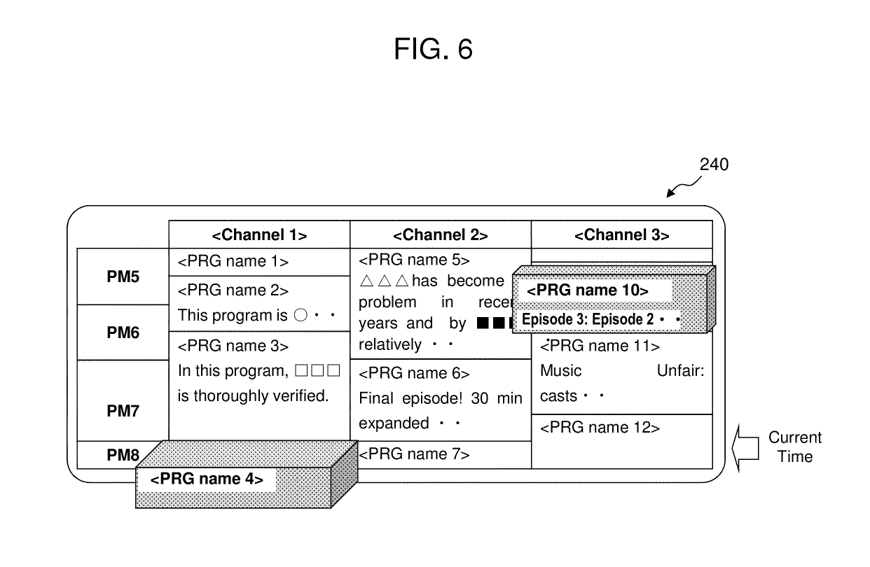

FIG. 6 is a screen image diagram when two hours have passed from the screen state of FIG. 5 keeping unchanged. The program information display unit 230 acquires the current time at predetermined time intervals (e.g. at 30 seconds intervals) and updates the display state of the program guide. Namely, as time passes, the time distance between the current time and each of program cells change, and the protrusion amounts of program cells are updated accordingly.

The current time in FIG. 6 is 20:00, thus the program cell of PRG name 4 having broadcast time closest to the current time protrudes more significantly, and the protrusion amount of the program cell of PRG name 10 is decreased than that of FIG. 5. By repeating this process at predetermined time intervals, the correspondence relationship between the current time and the protrusion amount of program cells can be appropriately maintained even keeping the program guide being displayed.

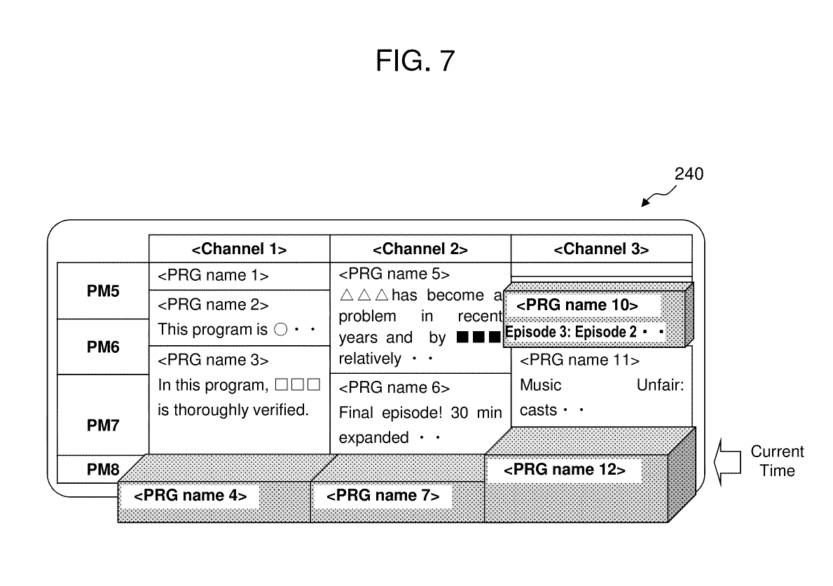

FIG. 7 is a screen image diagram showing a modified example of an operation in which the protrusion amount of the program cell near the current time is increased. In FIGS. 5 and 6, the protrusion amount is adjusted only for the program cells matching with the description of the user preference information 221. However, all program cells having broadcast time closest to the current time may be three-dimensionally displayed regardless of the description of the user preference information 221. In addition, regardless of the description of the user preference information 221, with the program cells having broadcast time closest to the current time being on top, the protrusion amount may be gradually decreased as broadcast time gets away from the top.

In FIGS. 5 to 7, the program information display unit 230 may adjust, when determining the protrusion amount, location, and the like of the program cells, these drawing parameters so that peripheral cells will not be hidden as described in the embodiment 1. Especially in the embodiment 2, the protrusion amount of 3D display is adjusted according to attributes such as current time, thus processing efficiency would be better if the program information display unit 230 would not mask peripheral cells when performing this adjustment.

### Embodiment 2

### Summary

As discussed above, the program information display device 200 according to the embodiment 2 protrudes the program cells having broadcast time close to the current time more frontward, thereby displaying the program cells three-dimensionally. This is based on an assumption that a program closer to the current time has higher importance. This operation can provide the user with a program selecting navigation with a perspective of time being added.

### Embodiment 3

In the embodiments 1 to 2, it is described that the program cells are three-dimensionally displayed. On the other hand, a. device having a function for displaying a screen in a 3D display format is usually capable of three-dimensionally displaying the program video itself. Thus in the embodiment 3 of the present invention, an operation example will be described in which the 3D display of the program guide and the 3D display of the program video itself are associated with each other.

In the embodiment 3, the program information display unit 230 includes a function for acquiring program videos corresponding to the program guide. Specifically, the program videos may be acquired from broadcast waves or program videos stored in storage media such as HDD may be acquired. Other configurations are the same as embodiments 1 to 2.

The user selects a program cell on the program guide provided by the program information display unit 230 and instructs the program information display device 200 to display the program. The program information display unit 230 acquires the relevant program video and instructs the screen display unit 240 to display it. At this time, if the program cell selected in advance by the user is displayed in a 3D display format, the program information display unit 230 displays the program video in a 3D display format. If the program video is originally created in a 3D display format, the program video is displayed as it is. If the program video is created in a 2D display format, the program video is converted into a 3D display format to be displayed. Any commonly known technique for 2D-3D conversion may be employed.

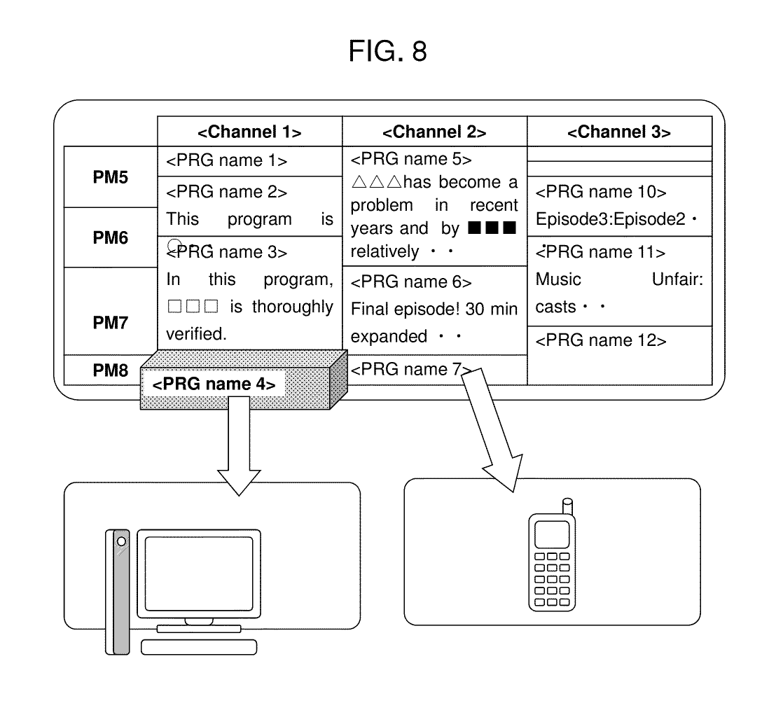

FIG. 8 is a diagram showing an operation example in which the display format of the program video is selected according to the display format of program cells. If the user selects a program cell displayed in a 3D display format (PRG name 4 in FIG. 8), the program information display unit 230 displays the relevant program video in a 3D display format. If the user selects a program cell displayed in a 2D display format (PRG name 7 in FIG. 8), the program information display unit 230 displays the relevant program video in a 2D display format.

### Embodiment 3

### Summary

As discussed above, if a user selects a program cell displayed in a 3D display format, the program information display device 200 according to the embodiment 3 displays the relevant program video in a 3D display format. Since the display format of the program cell and the display format of the program video correspond with each other, this allows the user to intuitively recognize whether the display effect of the program video is 2D or 3D.

Specifically, in a case where it is necessary to provide with the 3D video by functions of external devices such as 3D display glasses, the user is required to prepare such external devices in advance. According to the embodiment 3, the display format of the program videos can be notified by the display format of the program cells in advance, which is useful for such users. In addition, if 3D videos are suddenly presented without any precaution, users might misunderstand that the screen is. broken. In the light of such cases, the precaution may be effective.

### Embodiment 4

In the above-described embodiments 1 to 3, it is assumed that the program guide and the program videos are shown in different displays. On the other hand, the program guide and the program videos can be shown in a single display. One operation example for such cases will be described in the embodiment 4 of the present invention. The configuration of the program information display device 200 is the same as the embodiments 1 to 3.

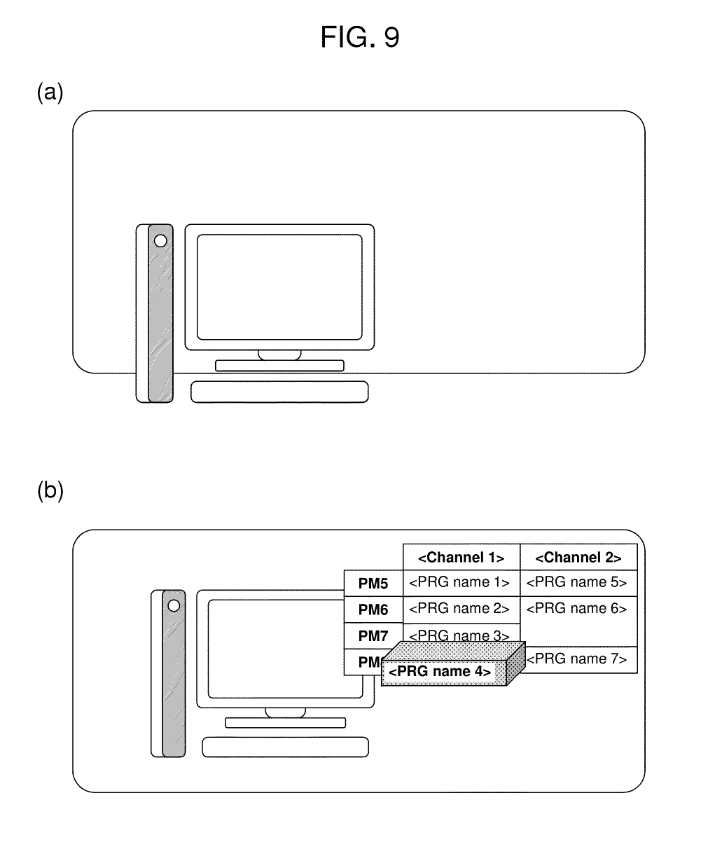

FIG. 9 is a screen image diagram in which the program video and the program guide are shown in the same display. FIG. 9(a) shows a screen image when displaying the program video in a 3D display format. FIG. 9(b) is a screen image when showing the program guide in the same display at the state of FIG. 9(a).

In FIG. 9(a), when displaying the program video in a 3D display format, the program information display unit 230 and the screen display unit 240 are displaying whole of the screen in a 3D display format. Thus whole of the screen is exhibiting the protrusion effect. When the user instructs the program information display device 200 to display the program guide in the same display using an operation unit of the program information display device 200, a remote controller, or the like, the program information display unit 230 and the screen display unit 240 switch the screen display from FIG. 9(a) into FIG. 9(b).

The method for displaying the program guide portion in FIG. 9(b) is the same as the embodiments 1 to 3. Namely, the program information display unit 230 displays the program cell matching with the description of the user preference information 221 in a 3D display format.

At this time, if the 3D display effect is provided for whole of the screen, even the program cells which are usually not protruded will be three-dimensionally displayed. Thus displaying the program cells matching with the user's favorites will be less effective. In addition, the program cells which are three-dimensionally displayed will be provided with the protrusion effect redundantly, which may cause disturbance in the screen.

Thus in the embodiment 4, the program information display unit 230 changes, when switching the display from FIG. 9(a) to FIG. 9(b), the program video into a 2D display format. In addition, the program information display unit 230 displays the program guide itself in a 2D display format. Only the program cells matching with the user preference information 221 will be converted into a 3D display format and will be displayed as described above. This allows the display format of the program video and the display format of the program guide to be consistent with each other, and both the 3D effect of the program guide and the 3D effect of the program cell can be exhibited.

If the user instructs the program information display device 200 to erase the program guide from the screen at the state of FIG. 9(b), the program information display unit 230 switches the screen display format back into that of FIG. 9(a), and displays the 3D program video.

### Embodiment 5

In the above-described embodiments 1 to 4, when three-dimensionally displaying the program cell, screen effects different from 2D display or additional information may be added. For example, screen effects or additional information mentioned below may be contemplated.

### (Additional Effect Example No. 1: Brightness)

Generally, if a 2D video is converted into a 3D display format, the screen image tends to be less brightened. Thus the program information display unit 230 sets the brightness of the program cells displayed in a 3D display format higher than that of other cells. This allows displaying the program cells in a 3D display format without a feeling of strangeness. The brightness of the program cells can be set higher by image processing in signal processing or by increasing the brightness of back lights behind the relevant program cells.

### (Additional Effect Example No. 2: Color)

The program information display unit 230 may display the program cells displayed in a 3D display format using different colors from those of other cells. This allows identifying the program cells displayed in a 3D display format more clearly. Such different colors may be provided for background colors or character colors, for example.

### (Additional Effect Example No. 3: Information Amount in Program Cells)

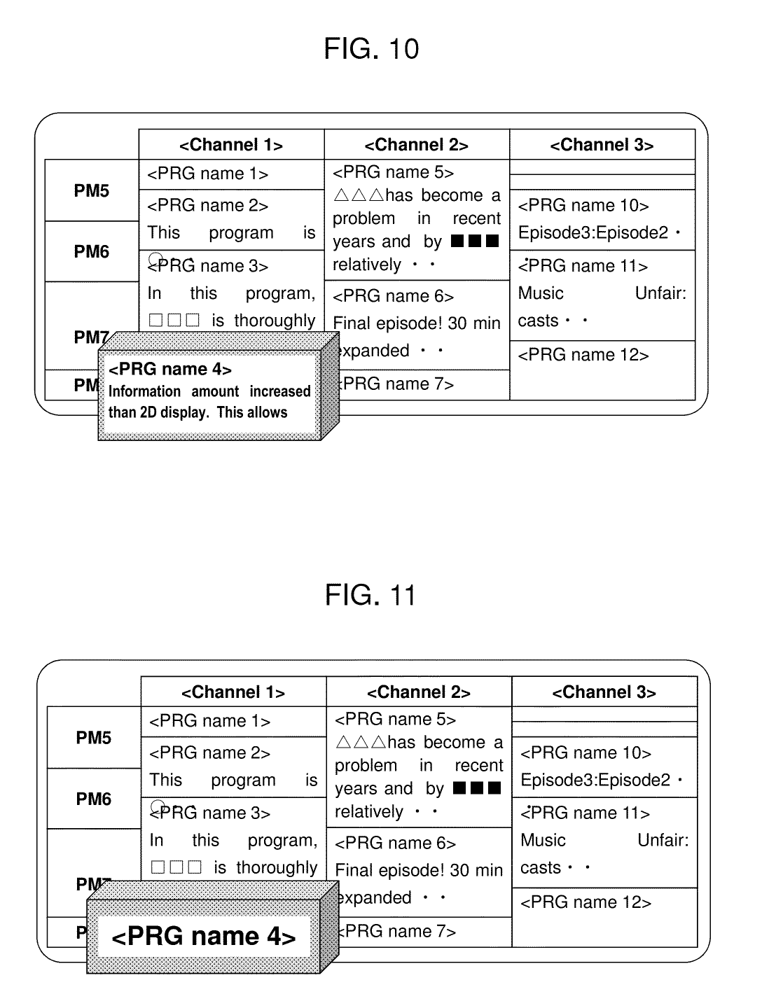

FIG. 10 is a diagram showing a configuration example in which the information amount of the program cell has been increased. The program information display unit 230 may describe more amount of information in the program cells displayed in a 3D display format than other cells. Specifically, the size of the three-dimensionally displayed program cell is set larger than that of other cells so that more amount of information can be described in it. The character size may be the same as that of before three-dimensionally displayed or may be adjusted according to the information amount to be described. By setting the program cell size larger than that of other cells, the visual effect of protruding the program cell frontward can be increased. In addition, increasing the information amount may be useful for users.

### (Additional Effect Example No. 4: Character Size in Program Cells)

FIG. 11 is a diagram showing a configuration example in which the character size of the program cell is enlarged. The program information display unit 230 may use a character size in the program cells displayed in a 3D display format larger than that of other cells. This allows increasing the visual effect of protruding the program cell frontward.

### (Additional Effect Example No. 5: Combination of Above)

The additional effect examples No. 1 to 4 can be combined arbitrarily. In addition, a switch button that turns ON/OFF any one of the additional effects may be provided in an operation unit such as a main operation unit or a remote controller, so that the user can turn ON/OFF the additional effects.

### Embodiment 6

In the embodiments 1 to 5, it is described that the protrusion amount of cells when three-dimensionally displaying the program cells is determined according to the importance of the program information. In the embodiment 6 of the present invention, a basis on which the importance of the program information is determined that is different from the basis of the embodiments 1 to 5 will be described.

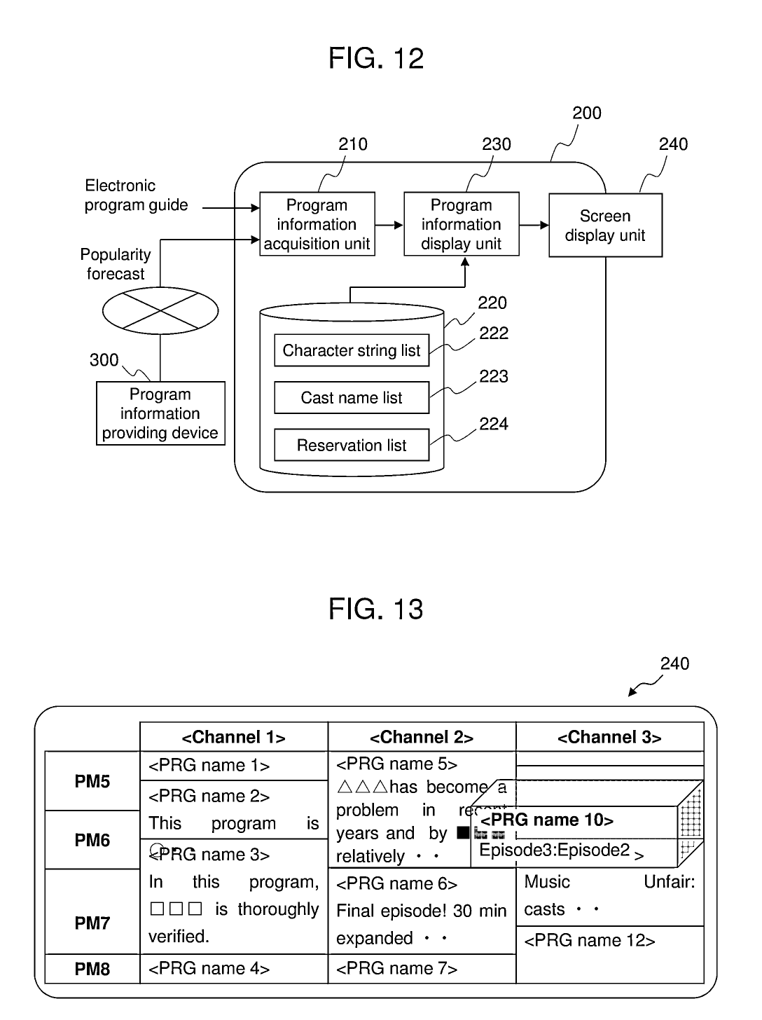

FIG. 12 is a functional block diagram of the program information display device 200 according to the embodiment 6. In the embodiment 6, the program information acquisition unit 210 acquires, in addition to the electronic program guide, information about popularity forecast for the programs that will be broadcasted in future from a program information providing device 300 located on a network (e.g. on the Internet). The storage unit 220 stores, in addition to the information described in the embodiments 1 to 5, a character string list 222, a cast name list 223, and a reservation list 224. Other configurations are the same as the embodiments 1 to 5.

The program information providing device 300 creates a popularity forecast of the programs that will be broadcasted in future according to popularity polls or questionnaires conducted by operators, and distributes the result thereof through networks. The popularity polls mentioned here has an aspect as information which can be consulted to determine whether the users of the program information display device 200 want to watch the relevant programs. Examples of such information could be: a result of audience rating forecast; information which indicates that the program will be broadcasted limited times (e.g. information which indicates that the program is a special program that will be broadcasted only once at the year's end); and so on.

The character string list 222 is a list describing, as character strings, items in which the user of the program information display device 200 has interests. The character string list 222 is prepared by the user and stored in the storage unit 220. The contents described in the character string list 222 may be parts of character strings assumed to be included in the program title, for example.

The cast name list 223 is a list describing cast names of programs in which the user of the program information display device 200 has interests. The cast name list 223 is prepared by the user and stored in the storage unit 220.

The reservation list 224 is a list describing information such as identifiers that specify programs programmed to record or programmed to view. In a case where the program information display device 200 performs programmed recordings or programmed views, the identifiers of such programs may be recorded. In a case where other devices perform programmed recordings or programmed views, the program information display device 200 may acquire the identifiers of the programmed programs by periodically inquiring such devices.

As described above, the configuration of the program information display device 200 according to the embodiment 6 is described. Next, an operation of the program information display device 200 in the embodiment 6 will be described. The program information display device 200 determines how much the three-dimensionally displayed program cells will be protruded according to any one of following methods.

### (Method for Determining Protrusion Amount No. 1: Popularity Forecast)

When three-dimensionally displaying program cells, the program information display unit 230 sets a larger protrusion amount as the popularity forecast of the program obtained from the program information providing device 300 becomes higher. This is to attract the user's eyes on the program because the user of the program information display device 200 is anticipated to view programs with high popularity forecast.

### (Method for Determining Protrusion Amount No. 2: Character String List 222)

When three-dimensionally displaying program cells, the program information display unit 230 sets a larger protrusion amount as the program includes within its program information more character strings described in the character string list 222. This is because the user is anticipated to view programs that include many items of interest of the user within the program information.

### (Method for Determining Protrusion Amount No. 3: Cast Name List 223)

When three-dimensionally displaying program cells, the program information display unit 230 sets a larger protrusion amount as the program includes within its program information more casts described in the cast name list 223. This is because the user is anticipated to view programs in which a lot of cast the user is concerned with appear. Whether cast names match may be determined by simple character strings comparison or small errors may be rounded and accepted.

### (Method for Determining Protrusion Amount No. 4: Reservation List 224)

When three-dimensionally displaying program cells, the program information display unit 230 sets a larger protrusion amount for programs described in the reservation list 224 than that of other programs. This is to remind the user that the program is programmed to be recorded. An icon indicating that the program is programmed to be recorded may be shown in the relevant program cell.

### (Method for Determining Protrusion Amount No. 5: Viewing History)

The program information display unit 230 periodically stores the user's viewing histories of programs in the storage unit 220, and sets a larger protrusion amount for programs viewed every time by the user as the viewing frequency of the program becomes higher. This is to remind the user because the user may not want to miss the program viewed every time by the user.

### (Method for Determining Protrusion Amount No. 6: Combination of Above)

The above-described methods No. 1 to 5 can be combined arbitrarily. For example, a program with high popularity forecast and in which cast described in the cast name list 223 appear may have larger protrusion amount than that of programs with high popularity forecast only. Alternatively, if information that indicates whether the program is a special program cannot be obtained from the program information providing device 300, the protrusion amount may be determined according to whether the program title includes titles that are typically added to special programs such as “special”. In this case, the character strings that are typically added to special programs may be described in the character string list 222.

### Embodiment 7

In the embodiment 1, it is described that, when program cells overlap each other by three-dimensionally displaying program cells, the program information is prevented from being hidden by adjusting drawing parameters of the program cells. In the embodiment 7 of the present invention, specific examples will be described in which program information is not hidden by adjusting program cell layouts. The configuration of the program information display device 200 is the same as the embodiments 1 to 6, thus adjusting program cell layouts will be mainly described.

FIG. 13 is a diagram showing a display example with the program cell being subtransparent. In FIG. 13, the three-dimensionally displayed program cell overlaps parts of adjacent program cells and parts of program information are hidden. Thus the program information display unit 230 draws the upper program cell subtransparently so that the contents of lower program cells can be transmissive to be seen.

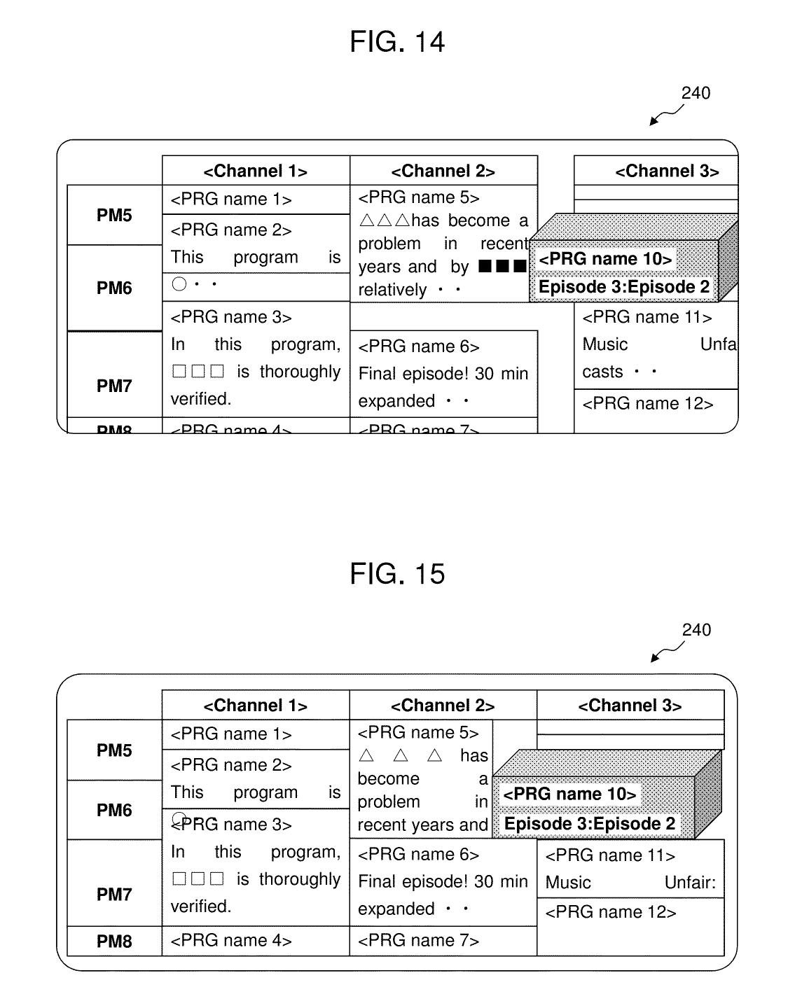

FIG. 14 is a diagram showing a display example in which the gap between program cells is expanded. In FIG. 14, the program information display unit 230 expands the gap between the three-dimensionally displayed program cell and its peripheral program cells to change the cell layout, so that the program cells don't overlap each other. In FIG. 14, the layouts of the program cells adjacent to the three-dimensionally displayed program cell are adjusted. However, the whole layout of the program guide may be readjusted so that the layout balance will not be crumbled. For example, cell gaps of all program cells may be expanded similarly.

FIG. 15 is a diagram showing a display example in which the program cell size is reduced. In FIG. 15, the size of peripheral cells covered by three-dimensionally displaying the program cell is reduced so that the program cells will not overlap each other. In FIG. 15, the layouts of the program cells adjacent to the three-dimensionally displayed program cell are adjusted. However, the whole layout of the program guide may be readjusted so that the layout balance will not be crumbled. For example, cell sizes of all program cells may be reduced similarly.

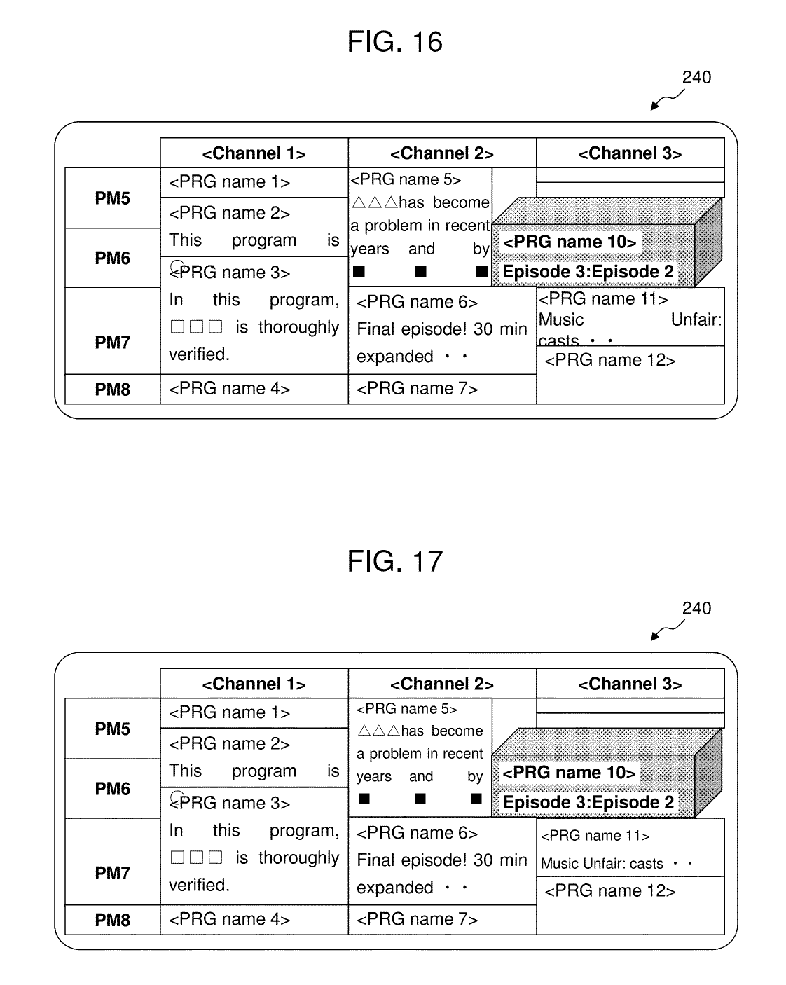

FIG. 16 is a diagram showing a display example in which the program cell size is reduced and the character gaps in the cell are narrowed. If the program cell size is reduced as in FIG. 15, the area for displaying the character strings in the cell will be narrowed. Thus the program information display unit 230 narrows the character gaps in the program cells which sizes are reduced, so that more character strings can be displayed within them.

FIG. 17 is a diagram showing a display example in which character string sizes of the program cell in reduced. Instead of narrowing the character gaps in the program cell, reducing character string sizes can exhibit the same effect. Sizes of all character strings in the cell may be reduced or sizes of a part of character strings such as program title portions may be reduced. As specific methods for reducing character string sizes, the character font can be changed into smaller ones. Alternatively, if the character strings are highlighted by edging effects, the edging may be removed to reduce the overall size of characters slightly.

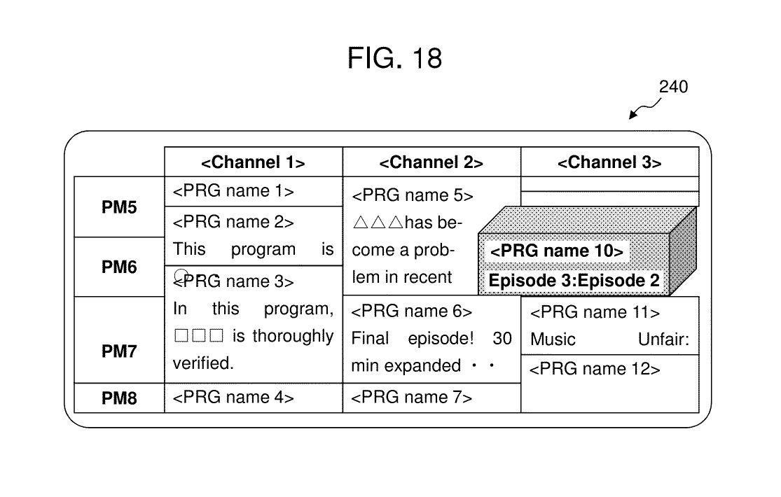

FIG. 18 is a diagram showing a display example in which the character arrangement in the program cell is changed. In FIGS. 13 to 17, the program information display unit 230 changes the program cell layouts so that program information does not overlap. In FIG. 18, the program cell layout is not changed. Alternatively, the arrangement of character strings is changed to prevent them from overlapping three-dimensionally displayed program cells, so that program information is not superimposed.

### Embodiment 7

### Summary

As described above, the embodiment 7 describes specific examples in which program information does not overlap each other when three-dimensionally displaying the program cell. Each of methods described in the embodiment 7 can be combined. For example, when the gaps between program cells may be slightly expanded to the extent in which the overall layout of the program guide is not crumbled and the program information still overlaps, the program cell size, the character string size, the character arrangement, and the like can be changed.

Regarding how much the program information display unit 230 should change the layouts of the program cell or character strings in order to prevent the program information from overlapping each other, it can be calculated according to the relationship between the display coordinates of the three-dimensionally displayed program cell and the display coordinates of other cells and the protrusion amount of the 3D effect.

### Embodiment 8

In the embodiment 8 of the present invention, a configuration example of a television receiver (television) in which the functions of the program information display device 200 described in the embodiments 1 to 7 are equipped will be described. The television according to the embodiment 8 comprises function units corresponding to each of function blocks of the program information display device 200 described in the embodiments 1 to 7. The correspondence between the configurations described in the embodiments 1 to 7 and the configuration according to the embodiment 8 will be described later.

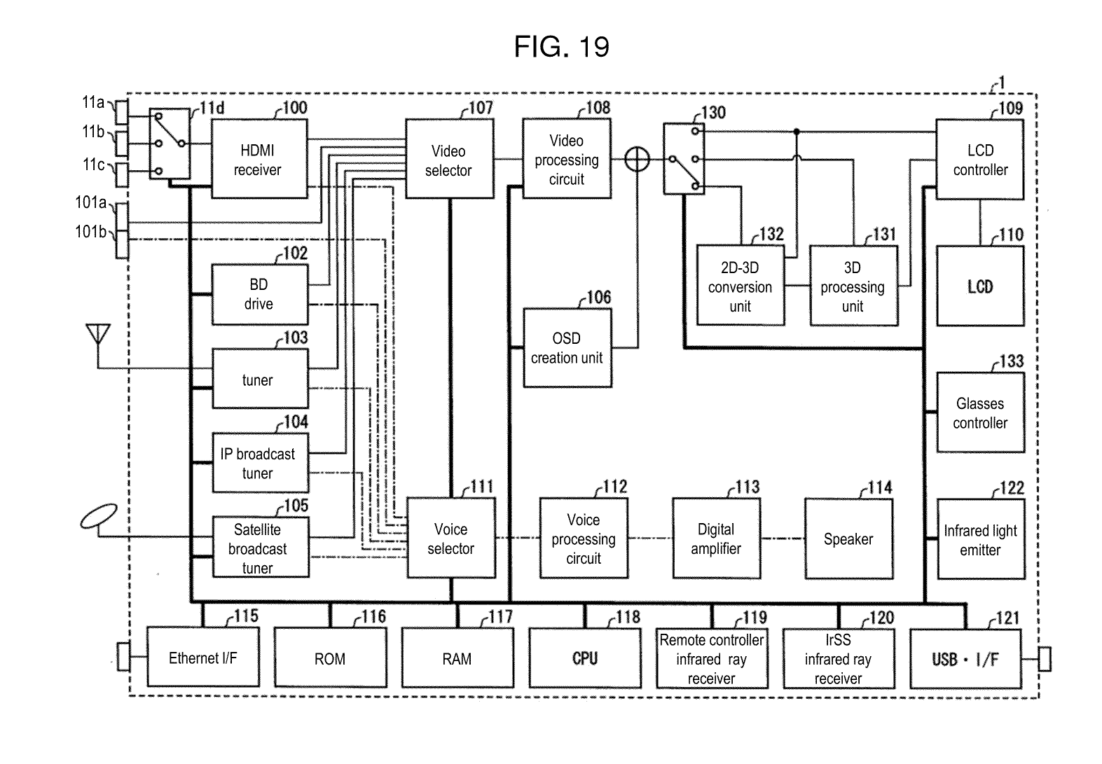

FIG. 19 is a block diagram showing a configuration of a television 1 according to the embodiment 8. As shown in FIG. 19, the television 1 comprises three HDMI input terminals 11a to 11c, a HDMI switch 11d, a HDMI receiver 100, a video input terminal 101a, a voice input terminal 101b, a BD (Blu-ray (registered trademark) Disc) drive 102, a tuner 103, an IP broadcast tuner 104, a satellite broadcast tuner 105, an OSD (On Screen Display) creation unit 106, a video selector 107, a video processing circuit 108, a LCD (Liquid Crystal Display) controller 109, a LCD 110, a voice selector 111, a voice processing circuit 112, a digital amplifier 113, a speaker 114, an Ethernet (registered trademark) I/F 115, a ROM (Read Only Memory) 116, a RAM (Random Access Memory) 117, a CPU 118, a remote controller infrared ray receiver 119, an IrSS infrared ray receiver 120, an USB I/F 121, a switch 130, a 3D processing unit 131, a 2D-3D conversion unit 132, and a glasses controller 133. In FIG. 19, the video signal path is shown with solid lines, the voice signal path is shown with dashed-dotted lines, and the data and control signal path (bus) is shown with thick lines.

(1) a video received by the HDMI receiver 100, (2) a video inputted from the video input terminal 101a, (3) a video read out from a BD by the BD drive 102, (4) a video received by the tuner 103, (5) a video received by the IP broadcast tuner 104, and (6) a video received by the satellite broadcast tuner 105 are provided to the video selector 107, respectively. (1) a voice received by the HDMI receiver 100, (2) a voice inputted from the voice input terminal 101b, (3) a voice read out from a BD by the BD drive 102, (4) a voice received by the tuner 103, (5) a voice received by the IP broadcast tuner 104, and (6) a voice received by the satellite broadcast tuner 105 are provided to the voice selector 111, respectively.

A channel selection control selecting one of: (a) which one of the HDMI input terminal the HDMI receiver 100 is connected with, namely which one of the HDMI input terminal the HDMI switch 11 d receives the content from and provides it to the HDMI receiver 100; (b) which one of channels the tuner 103 receives the content broadcasted through; (c) which one of servers the IP broadcast tuner 104 receives the content distributed from; and (d) which one of channels the satellite broadcast tuner 105 receives the content broadcasted through; is performed by the CPU 118. In addition, replay controls such as replay, stop, fast-forward, rollback, and chapter transition are also performed by the CPU 118.

The HDMI receiver 100, the BD drive 102, the tuner 103, the IP broadcast tuner 104, and the satellite broadcast tuner 105 have functions for extracting program information (electronic program guide) if they receive the program information along with video signals.

The video selector 107 selects one of: (1) a video provided from the HDMI receiver 100; (2) a video provided from the video input terminal 101a; (3) a video provided from the BD drive 102; (4) a video provided from the tuner 103; (5) a video provided from the IP broadcast tuner 104; and (6) a video provided from the satellite broadcast tuner 107. The video selected by the video selector 107 is provided to the video processing circuit 108. The CPU 118 controls which video is to be selected by the video selector 107.

The video processing circuit 108 adjusts the video quality provided from the video selector 107. The video processing circuit 108 also performs scaling of the video provided by the video selector 107. Adjusting the video quality mentioned here means that at least one of brightness, sharpness, and contrast is changed. Scaling means that the size of video is shrunk with the aspect ratio of the original video to be displayed being kept. The video which is provided with image quality adjustment and scaling by the video processing circuit 108 is provided to the switch 130. The CPU 118 controls how the video processing circuit 108 changes the image quality and how much the video is shrunk.

The OSD creation unit 106 creates an OSD image displayed and superimposed on the video outputted from the video processing circuit 108. The OSD image mentioned here includes the program guide. The OSD image created by the OSD creation unit 106 is added by an adder to the video provided from the video processing circuit 108 and is provided to the switch 130. If the video provided from the video processing circuit 108 is a 3D video such as a side-by-side scheme or a top-and-bottom scheme, the OSD creation unit 106 creates an OSD image corresponding to such schemes. However, it is an exception if the 3D program video and the program guide are displayed in the same screen as described in the embodiment 4. The CPU 118 controls what OSD images are created.

The OSD creation unit 106 also includes a function for decoding still images received by the IrSS infrared ray receiver 120 (hereinafter, also referred to as “received image”). If the received image is a 2D image, the OSD creation unit 106 creates a 2D video using the images obtained by decoding the 2D image as frame images, and provides the 2D video to the switch 130. If the received image is a 3D image, the OSD creation unit 106 creates a 3D video (side-by-side scheme or top-and-bottom scheme) using frame images including right eye images and left eye images obtained by decoding the 3D image, and provides the 3D video to the switch 130.

The OSD creation unit 106 may comprise, in addition to a decode buffer storing left eye images and right eye images obtained by decoding the received image, a display buffer storing left eye images and right eye images provided to the switch 130. Instead of using two storage units provided in the OSD creation unit 106 as the decode buffer and the display buffer, two areas provided in the RAM 117 may be used as the display buffer and the decode buffer.

The 2D video outputted from the video processing circuit 108 and the OSD creation unit 106 is directly provided to the LCD controller 109 if the display mode is a 2D display mode, and is provided to the LCD controller 109 through the 2D-3D conversion unit 132 and the 3D processing unit 131 if the display mode is a 3D display mode. The 3D video outputted from the video processing circuit 108 and the OSD creation unit 106 is provided to the LCD controller 109 through the 2D-3D conversion unit 132 if the display mode is a 2D display mode, and is provided to the LCD controller 109 through the 3D processing unit 131 if the display mode is a 3D display mode. Switching the path for providing video signals is implemented by the switch 130 as shown in FIG. 130.

The 3D processing unit 131 converts a 3D video (side-by-side scheme or top-and-bottom scheme) comprising frame images including both right eye images and left eye images into a 3D video comprising right eye frame images including right eye images only and left eye frame images including left eye images only. For example, if the video signal before conversion is a video signal of side-by-side scheme, the 3D processing unit 131: (1) creates the right eye frame image by doubly expanding the right half of each frame image included in the 3D video before conversion in lateral direction; (2) creates the left eye frame image by doubly expanding the left half of each frame image included in the 3D video before conversion in lateral direction; and (3) outputs the created right eye frame image and left eye frame image alternately. Therefore, the frame rate of the video outputted from the 3D processing unit 131 (e.g. 240 frames/sec) is twice the frame rate of the video inputted to the 3D processing unit 131 (e.g. 120 frames/sec).

The 2D-3D conversion unit 132 includes a function for creating quasi-3D videos from 2D videos and a function for extracting 2D videos from 3D videos. Specifically, the 2D-3D conversion unit 132 converts the 3D video provided from the video processing circuit 108 and the OSD creation unit 106 into a 2D video if the display mode is a 2D display mode, and converts the 2D video provided from the video processing circuit 108 and the OSD creation unit 106 into a quasi-3D video if the display mode is a 3D display mode. The conversion from a 2D video into a 3D video is achieved by, for example, creating a right eye image and a left eye image from frame images included in a 2D video, and by using an image including both the created right eye image and left eye image as frame images. The conversion from a 3D video into a 2D video is achieved by, for example, extracting a left eye image included in frame images included in a 3D video, and by using the extracted left eye image as frame images.

The 2D-3D conversion unit 132 also switches the display format of program cells of the program guide into a 2D display or a 3D display.

The voice selector 111 selects one of: (1) a voice provided from the HDMI receiver 100; (2) a voice provided from the video input terminal 101a; (3) a voice provided from the BD drive 102; (4) a voice provided from the tuner 103; (5) a voice provided from the IP broadcast tuner 104; and (6) a voice provided from the satellite broadcast tuner 105. The voice selected by the voice selector 111 is provided to the voice processing circuit 112. The CPU 118 controls which one of the voice is selected by the voice selector 111. Note that the video selection in the video selector 107 and the voice selection in the voice selector 111 are associated with each other. For example, when the video selector 107 selects the video provided from the HDMI receiver 100, the voice selector 111 selects the voice provided from the HDMI receiver 100.

The voice processing circuit 112 adjusts the volume and quality of the voice provided from the voice selector 111. Adjusting voice quality mentioned here means that frequency characteristics of the voice provided from the voice selector 111 are changed (e.g. emphasizing low and high frequencies). The voice that the voice processing circuit 112 adjusts its volume and quality is provided to the digital amplifier 113. The CPU 118 controls how the volume and quality is changed by the voice processing circuit 112.

The digital amplifier 113 drives the speaker 114 so that the voice provided from the voice processing circuit 112 is outputted. This allows the speaker 114 to output the voice selected by the voice selector 111.

The ROM 116 is a readable and unwritable memory storing constant data such as programs executed by the CPU 118. The ROM 116 also stores JPEG data or SVG (Scalable Vector Graphics) data referred to by the OSD creation unit 106 to create OSD images. The ROM 116 may be an EEPROM.

The RAM 117 is a readable and writable memory storing variable data such as data referred to by the CPU 118 for calculation and data created by the CPU 118 in calculations. The RAM 117 also stores the received images received by the IrSS infrared receiver 120. The Ram 117 may be a hard disk drive or a Flash memory.

The Ethernet I/F 115 is an interface for connecting the television 1 with networks. The above-mentioned IP broadcast tuner 105 accesses servers on the Internet through the Ethernet I/F 115. The Ethernet I/F 115 may be an interface for connecting with LAN cables or an interface for connecting with coaxial cables.

The Ethernet I/F 115 is not limited to wired cables. For example, it may be an interface for connecting with wireless networks such as a wireless LAN, a Bluetooth (registered trademark), and a Wifi.

The remote controller infrared ray receiver 119 receives remote control signals from a remote controller. The remote controller infrared ray receiver 119 notifies the received remote controller signals to the CPU 118.

The IrSS infrared ray receiver 120 is a means for receiving still images transmitted by near field communication using IrSS from a digital camera or the like. The IrSS infrared ray receiver 120 notifies the received image to the CPU 118.

The USB OF 121 is an interface for connecting the television 1 with USB memories. The television 1 refers to data in USB memories through the USB OF 121. The USB I/F 121 is not limited to interfaces for connecting with USB memories. For example, it may be an interface for connecting with SD cards, or an interface for connecting with external hard disk drives or BD drives.

The LCD controller 109 drives the LCD 110 so that the videos provided through the switch 130, the image received by the IrSS infrared ray receiver, and the image converted by the 2D-3D conversion unit 132 are displayed. This allows the LCD 110 to output the video selected by the video selector 107 or the received image received by the IrSS infrared ray receiver 120. When OSD images are provided from the OSD creation unit 106, the LCD controller 109 superimposes the OSD image provided from the OSD creation unit 107 on the video or the received image to display them.

The LCD controller 109 also changes panel drive speeds and configures 3D glasses drives. The LCD controller 109 notifies to the glasses controller 133, when performing 3D display, the display timings of the left eye images and right eye images configured in driving 3D glasses.

The glasses controller 133 controls the infrared ray emitter 122 to transmit control signals controlling a 3D glasses of active shutter glasses scheme in synchronization with the display timing received from the LCD controller 109. The active shutter glasses scheme is a scheme in which lenses of a 3D glasses are opened and closed alternately in synchronization with the timings when the television 1 displays the left eye videos and right eye videos alternately.

The CPU 118 controls each of the above-mentioned units according to the remote controller signals received by the remote controller infrared ray receiver 119. As a control using the remote controller infrared ray receiver 119, switching the channels selected by the tuner 103 according to the remote controller signals, and switching the videos and voices selected by the video selector 107 and the voice selector 111 according to the remote controller signals can be exemplified. The switch 130 is controlled so that the image displayed on the LCD 110 is switched from 2D display to 3D display or from 3D display to 2D display.

The CPU 118 is a means for determining whether the received image received by the IrSS infrared ray receiver 120 is a 2D image or a 3D image. The CPU 118 stores the received image into the RAM 117 and notifies the determination result and the received image to the OSD creation unit 106. The CPU 118 also controls the switch 130 so that the processing is switched according to the determination result.

The program information acquisition unit 210 in the embodiments 1 to 5 corresponds to the HDMI receiver 100, the BD drive 102, the tuner 103, the IP broadcast tuner 104, and the satellite broadcast tuner 105. The storage unit 220 corresponds to the ROM 116 or the RAM 117. The program information display unit 230 corresponds to the OSD creation unit 106, the video processing circuit 108, the 2D-3D conversion unit 132, and the 3D processing unit 131. The screen display unit 240 corresponds to the LCD controller 109 and the LCD 110.

### Embodiment 8

### Summary

As described above, the embodiment 8 describes the configuration of the television 1 equipping the functions of the program information display device 200 described in the embodiment 1 to 6. As other examples of devices equipping the functions of the program information display device 200, a program recording device, a mobile terminal that can receive television broadcasts, and the like can be contemplated.

### Embodiment 9

Each of the function units of the program information display device 200 described in the embodiments 1 to 7 and each of the function blocks of the television 1 described in the embodiment 8 can be implemented by hardware using logic circuits formed on integrated circuits (IC chips), or can be implemented by software using CPUs.

In the latter case, the program information display device 200 and the television 1 comprise a CPU executing program instructions implementing each of functions, a ROM storing the program, a RAM in which the program is stored, a storage device (storage medium) such as a memory storing the program and various types of data, and the like. The objective of the present invention can be achieved by providing the program information display device 200 and the television 1 with a storage medium computer-readably storing program codes (executable programs, intermediate code programs, source programs) of control programs of the program information display device 200 or the television 1 that implement above-mentioned functions.

As the above-mentioned storage medium. for example, tapes such as magnetic tapes or cassette tapes, magnetic disks such as floppy (registered trademark) disks/hard disks, disks including optical disks such as CD-ROM/MO/MD/DVD/CD-R, cards such as IC cards (including memory cards)/optical cards, semiconductor memories such as masked ROM/EPROM/EEPROM/flash ROM, or logic circuits such as PLD (Programmable Logic Device) or FPGA (Field Programmable Gate Array) can be used.

The program information display device 200 or the television 1 may be configured to be connectable with communication networks, and the above-mentioned program codes may be provided through the communication networks. The communication network is not limited as long as it can transmit the program codes. For example, the Internet, intranets, extranets, LAN, ISDN, VAN, CATV communication networks, Virtual Private Network, telephone networks, mobile communication networks, satellite communication networks, and the like can be used. The transmission medium configuring the communication network is not limited to specific configurations or types as long as it can transmit the program codes. For example, wire communications such as IEEE 1394, USB, electric power line communications, cable TV networks, telephone networks, ADSL (Asymmetric Digital Subscriber Line) networks, and the like or wireless communications such as infrared rays like IrDA or remote controller, Bluetooth (registered trademark), IEEE 802.11 wireless communication, HDR (High Data Rate), NFC (Near Field Communication), DLNA (Digital Living Network Alliance), mobile phone networks, satellite networks, digital terrestrial networks, and the like can be used.

The present invention is not limited to the above-mentioned embodiments and various modifications are possible within the scope of claims. Namely, embodiments obtained by combining technical means arbitrarily modified within the scope of claims are also included in the technical scope of the present invention.

### REFERENCE SIGNS LIST

1: television, 11a to 11c: HDMI input terminal, 11d: HDMI switch, 100: HDMI receiver, 101a: video input terminal, 101b: voice input terminal, 102; BD drive, 103; tuner, 104: IP broadcast tuner, 105: satellite broadcast tuner, 106: OSD creation unit, 107: video selector, 108: video processing circuit, 109: LCD controller, 110: LCD, 111: voice selector, 112: voice processing circuit, 11.3: digital amplifier, 114: speaker, 115: Ethernet I/F, 116: ROM, 117: RAM, 118: CPU, 119: remote controller infrared ray receiver, 120: IrSS infrared ray receiver, 121: USB I/F, 122: infrared ray emitter, 130: switch, 131: 3D processing unit, 132: 2D-3D conversion unit, 133: 3D glasses controller, 200: program information display device, 210: program information acquisition unit, 220: storage unit, 221: user preference information, 2211: attribute type column, 2212: attribute value column, 2213: attribute importance column, 230: program information display unit, 240; screen display unit

1. A program information display device that displays program information, comprising: a program information acquisition unit that acquires program information;
a program information display unit that displays the program information acquired by the program information acquisition unit; and
a storage unit that stores user preference information describing a preference of a user regarding a program or a program attribute and an importance of the program or the program attribute,
wherein
the program information display unit, when displaying the program information, three-dimensionally displays program information of the program matching with a preference described in the user preference information,
wherein
the higher the importance of the program or the program attribute described in the user preference information is, the larger the program information display unit sets a protrusion amount of the three-dimensional display,
and wherein
if the program information display unit receives, while displaying an acquired program video in a 3D display format, an instruction to display program information in the same screen,
the program information display unit
switches the program video into a 2D display format and displays the program information in a 2D format, and
if program information of a program matching with a preference described in the user reference information is included in the program information three-dimensionally displays the matched program information.

2. The program information display device according to claim 1, wherein
the program information display unit, when displaying the program information, adjusts the protrusion amount of the three-dimensional display so that the program looks protruded more frontward as a broadcast time of the program gets closer to current time.

3. The program information display device according to claim 2, wherein
the program information display unit, while displaying the program information,
repeatedly acquires the current time at a predetermined interval, and
when acquiring the current time, adjusts the protrusion amount of the three-dimensional display so that the program looks protruded more frontward as a broadcast time of the program gets closer to the current time.

4. The program information display device according to claim 1, wherein
if the program information display unit receives an instruction to display a program video corresponding to three-dimensionally displayed program information, the program information display unit acquires the program video and starts displaying the program video in a 3D display format.

5. (canceled)

6. The program information display device according to claim 1, wherein
if the program information display unit receives, while displaying an acquired program video in a 3D display format, an instruction to erase the program information from the screen and to display a program video only after receiving an instruction to display program information in the same screen, the program information display unit sets the program video back into a 3D display format and displays the program video.

7. The program information display device according to claim 1, wherein
the program information display unit, when three-dimensionally displaying program information, sets a brightness of the program information higher than that of when not three-dimensionally displaying the program information.

8. The program information display device according to claim 1, wherein
the program information display unit, when three-dimensionally displaying program information, describes a more amount of information displayed by the program information than that of when not three-dimensionally displaying the program information.

9. The program information display device according to claim 1, wherein
the program information display unit, when three-dimensionally displaying program information, sets a character size of the program information larger than that of when not three-dimensionally displaying the program information.

10. The program information display device according to claim 1, wherein
the program information display unit, when three-dimensionally displaying program information, sets a display color of the program information different from that of when not three-dimensionally displaying the program information.

11. The program information display device according to claim 1, wherein
the program information display unit, when three-dimensionally displaying program information, adjusts a drawing parameter of three-dimensionally displayed program information so that three-dimensionally displayed program information does not mask other program information.

12. The program information display device according to claim 1, wherein
the storage unit stores a history describing the user's viewing history of program, and
the program information display unit, when displaying the program information, adjusts the protrusion amount of the three-dimensional display so that the higher a viewing frequency of the program recorded in the history is, the more the program looks protruded frontward.

13. The program information display device according to claim 1, wherein
the program information acquisition unit acquires, from a program information providing device on a network, a popularity forecast of a program that will be broadcasted in future, and
the program information display unit, when displaying the program information, adjusts the protrusion amount of the three-dimensional display so that the higher the popularity forecast acquired by the program information acquisition unit is, the more the program looks protruded frontward.

14. The program information display device according to claim 1, wherein
the storage unit stores a character string list describing a character string indicating that the importance is high, and
the program information display unit, when displaying the program information, adjusts the protrusion amount of the three-dimensional display so that the more character strings described in the character string list the program's program information includes, the more the program looks protruded frontward.

15. The program information display device according to claim 1, wherein
the storage unit stores a cast name list describing a cast name of a program, and
the program information display unit, when displaying the program information, adjusts the protrusion amount of the three-dimensional display so that the more cast names described in the cast name list the program's program information includes as the program's cast names, the more the program looks protruded frontward.

16. The program information display device according to claim 1, wherein
the storage unit stores a reservation list describing an identifier of a program programmed to record or programmed to view, and
the program information display unit, when displaying the program information, adjusts the protrusion amount of the three-dimensional display so that a program described in the reservation list looks protruded more frontward than other programs.

17. The program information display device according to claim 1, wherein
the program information display unit, when displaying the program information, sets three-dimensionally displayed program information subtransparent if three-dimensionally displayed program information overlaps other program information.

18. The program information display device according to claim 1, wherein
the program information display unit, when displaying the program information, changes a program information layout so that three-dimensionally displayed program information does not completely hide other program information if three-dimensionally displayed program information overlaps other program information.

19. The program information display device according to claim 18, wherein
the program information display unit, when displaying the program information, changes a program information layout by expanding a gap between program cells if three-dimensionally displayed program information overlaps other program information.

20. The program information display device according to claim 18, wherein
the program information display unit, when displaying the program information, changes a program information layout by shrinking a size of at least one of program cells overlapping each other if three-dimensionally displayed program information overlaps other program information.

21. The program information display device according to claim 20, wherein
the program information display unit, when displaying the program information, after shrinking a size of at least one of program cells overlapping each other narrows a character gap in the shrunk program cell if three-dimensionally displayed program information overlaps other program information.

22. The program information display device according to claim 20, wherein
the program information display unit, when displaying the program information, after shrinking a size of at least one of program cells overlapping each other shrinks a size of at least a part of characters in the shrunk program cell if three-dimensionally displayed program information overlaps other program information.

23. The program information display device according to claim 22, wherein
the program information display unit shrinks a character size in the shrunk program cell by removing an edge of character.

24. The program information display device according to claim 22, wherein
the program information display unit shrinks a character size in the shrunk program cell by changing a character font size into a smaller one.

25. The program information display device according to claim 18, wherein
the program information display unit, when displaying the program information, changes a program information layout by reallocating a program information character string described in a program cell located lower among program cells overlapping each other into a shifted location so that the program information character string does not overlap a program cell located upper among the program cells overlapping each other.

26. A television receiver comprising the program information display device according to claim 1.

27. A program information display method for displaying program information, comprising:
a program information acquisition step acquiring program information;
a program information display step displaying the program information acquired in the program information acquisition step; and
a step acquiring, from a storage device that stores user preference information describing a preference of a user regarding a program or a program attribute and an importance of the program or the program attribute, the user preference information,
wherein
in the program information display step, when displaying the program information, program information of the program matching with a preference described in the user preference information is three-dimensionally displayed,
wherein
the higher the importance of the program or the program attribute described in the user preference information is, the larger a protrusion amount of the three-dimensional display is set,
and wherein
in the program information display step, while displaying an acquired program video in a 3D display format, if an instruction to display program information in the same screen is received,
in the program information display step,
the program video is switched into a 2D display format and the program information is displayed in a 2D format, and
if program information of a program matching with a preference described in the user preference information is included in the program information, the matched program information is three-dimensionally displayed.

28. A program information display program that causes a computer to execute the program information display method according to claim 27.

29. A computer readable storage medium that stores the program information display program according to claim 28.
